(19) United States
(12) Patent Application Publication
(10) Pub. No.: US 2026/0340724 A1
(43) Pub. Date: Oct. 29, 2026

(54) HARDWARE-ATTESTED REGULATORY-COMPLIANT WRAPPER FOR PREDICTION MARKET INSTRUMENTS

(71) Applicant: George William Bickerstaff, III, Greenwich, CT (US)

(72) Inventor: George William Bickerstaff, III, Greenwich, CT (US)

(21) Appl. No.: 19/714,029

(22) Filed: Jun. 19, 2026

(51) Int. Cl. G06Q 40/04

(52) U.S. Cl. CPC G06Q 40/052; G06Q 2220/00

(57) ABSTRACT

A hardware-attested system transforms native prediction market contracts into institutionally consumable wrapped derivative instruments within a trusted execution environment. The system ingests native contract specifications, position records, and pseudonymized participant-identity records, applies know-your-customer, anti-money-laundering, sanctions, and eligibility screening against a committed rule set sealed to the hardware, and integrates attested trade-integrity and confidence-scoring inputs from companion systems without recomputing them. A jurisdictional mapping module assigns a regulatory designation and a capital treatment mapping module assigns capital attributes under the Standardized Approach for Counterparty Credit Risk using a committed supervisory factor table and alpha multiplier. The system emits a compliance attestation record binding the wrapped instrument definition and capital attributes to the hardware and to commitments over the inputs and methodology, independently verifiable by a regulator or institutional counterparty against a hardware-vendor attestation service without reliance on the exchange operator.

### CROSS-REFERENCE TO RELATED APPLICATIONS

This application claims the benefit of U.S. Provisional Application No. 64/044,058, filed Apr. 20, 2026, the entire contents of which are incorporated herein by reference. This application is related to commonly-owned co-pending applications directed to companion systems including a hardware-attested trade integrity system (HATIS), a verified prediction confidence scoring engine (VPCS), a resolution-outcome oracle (Oracle Resolution), a federated stack orchestrator (FSO), and a multi-exchange consolidated platform (MECP), the contents of which are incorporated herein by reference to the extent consistent herewith.

### FIELD OF THE INVENTION

The present invention relates to regulated financial market infrastructure, and more particularly to a hardware-attested system that transforms native prediction market contracts into institutionally consumable wrapped derivative instruments, assigning regulatory capital treatment under the Standardized Approach for Counterparty Credit Risk within a hardware trusted execution environment and producing an independently verifiable compliance attestation over the transformation.

### BACKGROUND OF THE INVENTION

Institutional participants subject to prudential capital regulation cannot treat a native prediction market contract as a recognized derivative instrument without a defensible mapping to a regulatory designation, a capital treatment, and a reporting classification. Producing that mapping requires sensitive participant and position data, the application of complex jurisdictional and capital rules, and a result that a prudential regulator or counterparty can trust.

A software-only wrapper affords a relying party no cryptographic means of confirming that the capital treatment and regulatory classification were computed correctly, under the stated methodology, on unaltered inputs, by unmodified code, without exposing the underlying participant data. No exchange operator can be relied upon by an institutional counterparty to self-certify the capital treatment of instruments it lists. A clear need exists for a hardware-attested wrapper that performs screening, jurisdictional mapping, and capital-treatment assignment within a hardware-protected enclave, and emits a compliance attestation that an institution or regulator can verify independently—against a hardware-vendor attestation service—without reliance on the exchange operator and without exposing per-participant data. The present invention addresses this need.

### SUMMARY OF THE INVENTION

The invention is directed to a hardware-attested regulatory-compliant wrapper system comprising a compliance processing engine, an intake interface, a screening module, a jurisdictional mapping module, a capital treatment mapping module, and an attestation module, each executing within a hardware trusted execution environment (TEE).

In one aspect, the system ingests native prediction market contract specifications, position records, and pseudonymized participant-identity records into the TEE; applies KYC/AML, sanctions, and eligibility screening against a committed rule set sealed to the hardware; maps the native contract to a wrapped instrument definition with treatment attributes under a committed jurisdictional rule set; assigns capital treatment attributes under a committed capital mapping methodology comprising a replacement cost component, a potential future exposure component computed under the Standardized Approach for Counterparty Credit Risk (SA-CCR) using a committed supervisory factor table and a committed alpha multiplier, and an exposure-at-default value with committed netting; and produces a compliance attestation record cryptographically signed by the hardware-rooted attestation key binding the wrapped instrument and capital treatment attributes to the hardware measurement register and to cryptographic commitments over the ingested records and committed parameters.

Consistent with the companion-system architecture, the wrapper integrates as received attested input the account-linkage fingerprints and raw trade-integrity signals generated by the HATIS companion and the calibrated insider-risk indicator computed by the VPCS companion; the wrapper itself performs neither raw trade-integrity detection nor calibrated insider-risk scoring. The compliance attestation is independently verifiable by a regulator or institutional counterparty against a hardware-vendor attestation service without participation of, or reliance on representations by, the prediction market exchange operator.

### BRIEF DESCRIPTION OF THE DRAWINGS

FIG. 1 depicts the regulatory-compliant wrapper system architecture and its trust model, in subfigures FIG. 1A through FIG. 1E.

FIG. 2 depicts the end-to-end wrapping method sequence, in subfigures FIG. 2A through FIG. 2E.

FIG. 3 depicts jurisdictional rule mapping and instrument transformation, in subfigures FIG. 3A through FIG. 3E.

FIG. 4 depicts the SA-CCR capital treatment mapping, in subfigures FIG. 4A through FIG. 4E.

FIG. 5 depicts the compliance attestation and regulatory reporting export architecture, in subfigures FIG. 5A through FIG. 5E.

### DETAILED DESCRIPTION OF PREFERRED EMBODIMENTS

### Definitions

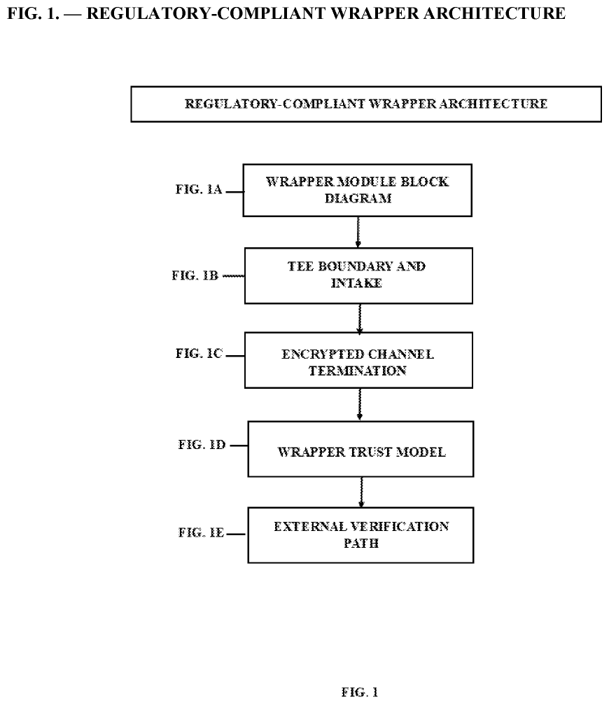

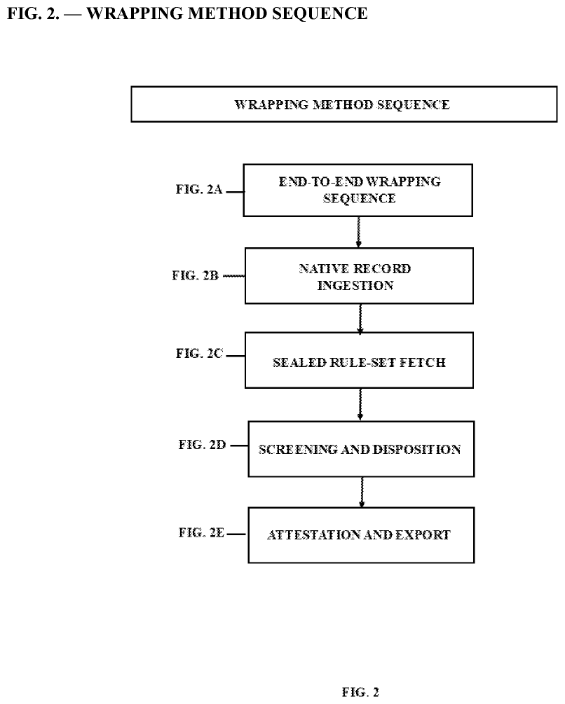

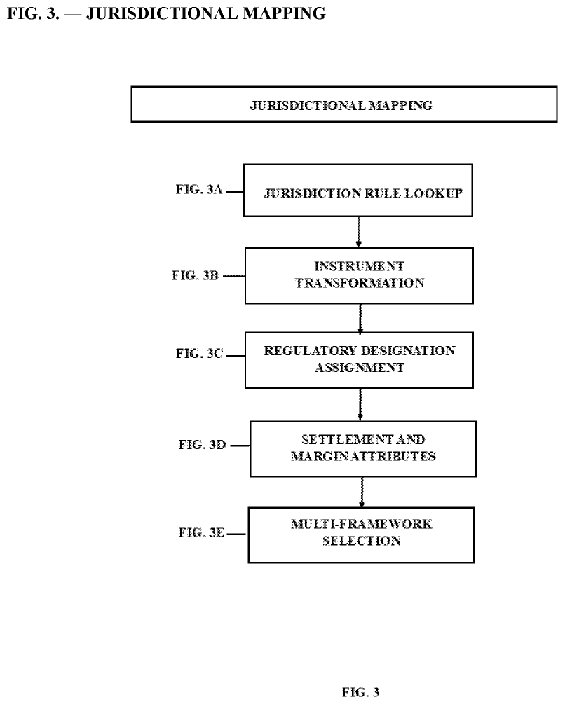

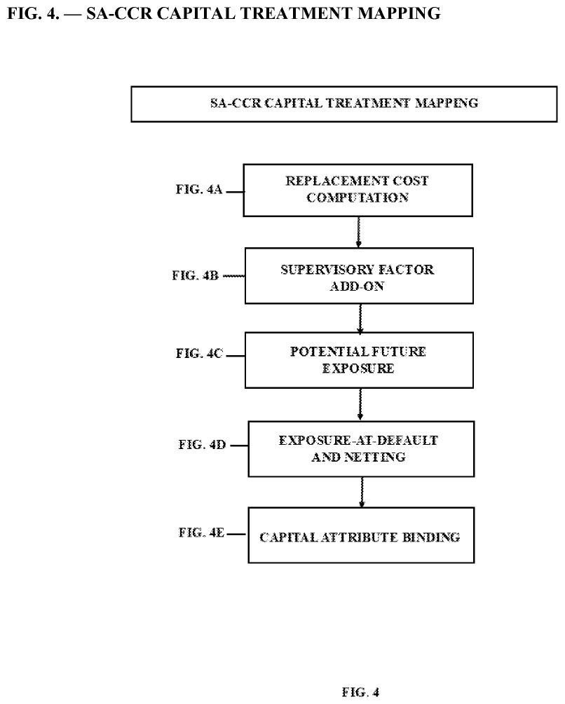

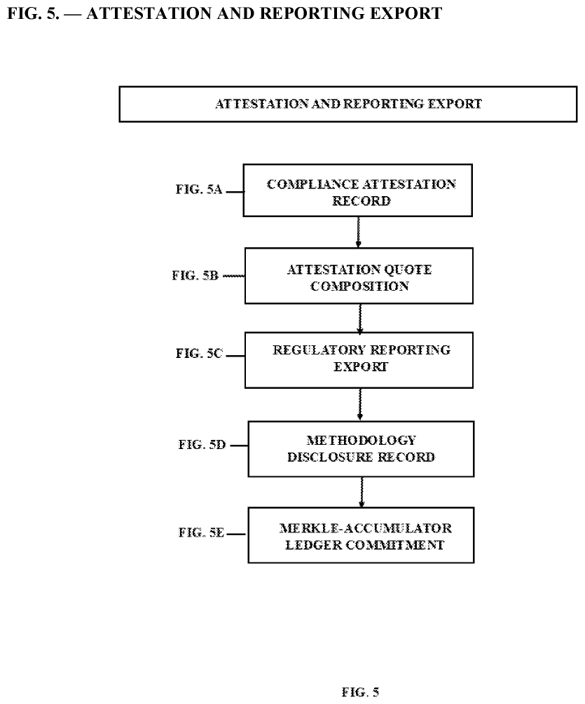

As used herein, the following terms have the meanings set forth below. The definitions are inclusive and non-limiting; each term includes, but is not limited to, the described subject matter.
“Capital Treatment Attributes” means attributes assigned to a wrapped instrument definition under a committed capital mapping methodology, including but not limited to a replacement cost component, a potential future exposure component, and an exposure-at-default value.
“Committed Capital Mapping Methodology” means a methodology, committed and sealed to the hardware identity of the hardware trusted execution environment, for computing capital treatment attributes, including but not limited to a methodology computing potential future exposure under the Standardized Approach for Counterparty Credit Risk using a committed supervisory factor table and a committed alpha multiplier.
“Compliance Attestation Record” means a record produced within the hardware trusted execution environment and cryptographically signed by the hardware-rooted attestation key, binding the wrapped instrument definition attributes and capital treatment attributes to the hardware measurement register and to cryptographic commitments over the ingested records and committed parameters.
“Compliance Processing Engine” means a component executing within the hardware trusted execution environment configured to coordinate screening, jurisdictional mapping, capital treatment mapping, and attestation for native prediction market contracts, including but not limited to an engine integrating attested companion inputs.
“Hardware Measurement Register” means a hardware-protected register whose contents cryptographically bind to a measured code base upon instantiation, including but not limited to platform configuration registers and equivalent measurement facilities.
“Hardware-Rooted Attestation Key” means a cryptographic key provisioned by a hardware vendor used to sign attestation records verifiable against a hardware-vendor attestation service, including but not limited to keys underlying Intel, AMD, ARM, or IBM attestation infrastructures.
“Native Prediction Market Contract” means an event or prediction contract as listed natively by a prediction market exchange, including but not limited to a binary or categorical event contract, prior to transformation into a wrapped instrument definition.
“Standardized Approach for Counterparty Credit Risk (SA-CCR)” means a counterparty credit risk exposure methodology computing exposure at default from a replacement cost component and a potential future exposure component, the latter derived from supervisory factors and an alpha multiplier, including but not limited to the approach applied to derivative exposures under applicable prudential capital frameworks.
“Trusted Execution Environment (TEE)” means a hardware-protected execution environment providing measurement, isolation, and remote attestation, including but not limited to Intel SGX, Intel TDX, AMD SEV-SNP, ARM CCA, and IBM Secure Execution.
“Wrapped Instrument Definition” means a derivative instrument definition produced by transforming a native prediction market contract, with institution-specific treatment attributes assigned under a committed jurisdictional rule set, including but not limited to assigned notional, settlement mechanics, margining parameters, and regulatory designation.
I. Wrapper System Architecture. FIG. 1 depicts a regulatory-compliant wrapper system organized around a compliance processing engine executing within a hardware trusted execution environment, the engine comprising a screening module, a jurisdictional mapping module, a capital treatment mapping module, a reporting transformation module, and an attestation module (FIG. 1A). A native data intake interface delivers native contract, position, and pseudonymized participant-identity records into the enclave over encrypted channels terminating within the TEE boundary, with plaintext isolation from the host (FIG. 1B-1C). The trust model comprises the hardware measurement register, the hardware-rooted attestation key, the sealed committed rule sets, and the hardware-vendor attestation service as external trust anchor (FIG. 1D-1E).
II. Intake and Companion Integration. The intake interface ingests native prediction market contract specifications, associated position records, and participant-identity records comprising pseudonymized identifiers derived from cryptographic hashes of KYC attestation data, such that plaintext of said records does not exist outside the enclave during a computation interval (FIG. 2B). The compliance processing engine integrates, as received attested input, account-linkage fingerprints and raw trade-integrity signals from the HATIS companion and the calibrated insider-risk indicator from the VPCS companion, performing neither raw detection nor scoring itself.
III. Screening Module. The screening module applies KYC, AML, sanctions, and eligibility screening against a committed rule set sealed to the hardware identity of the enclave, producing a screened record with a composite risk score and a disposition indicator (FIG. 2D). The composite risk score incorporates the attested companion inputs without the wrapper re-computing them.
IV. Jurisdictional Mapping Module. The jurisdictional mapping module maps the native contract to a wrapped instrument definition with institution-specific treatment attributes under a committed jurisdictional rule set, maintaining jurisdiction-specific rule sets for U.S. CEA-designated contract markets, U.S. SEC-registered securities exchanges, EU equivalents, and other foreign regulatory regimes, and transforming a native binary or categorical event contract into a wrapped derivative instrument definition with assigned notional, settlement mechanics, margining parameters, and clearinghouse intermediation attributes (FIG. 3A-3E).
V. SA-CCR Capital Treatment Mapping Module. The capital treatment mapping module assigns capital treatment attributes under a committed capital mapping methodology. In a preferred embodiment the replacement cost is computed as the greater of zero and the difference between current market value and net collateral; the potential future exposure is computed under SA-CCR as the product of the committed alpha multiplier, an aggregate add-on derived from the committed supervisory factor table applied to the adjusted notional of the wrapped instrument, and a multiplier reflecting over-collateralization and negative mark-to-market; and the exposure at default is the committed alpha multiplier times the sum of the replacement cost and the potential future exposure, with netting applied under a committed netting determination (FIG. 4A-4E). The capital treatment attributes are computed deterministically within the enclave and bound into the compliance attestation record.
VI. Attestation, Reporting, and Ledger. The attestation module produces a compliance attestation record cryptographically signed by the hardware-rooted attestation key, binding the wrapped instrument definition attributes and capital treatment attributes to the hardware measurement register and to cryptographic commitments over the ingested records and committed rule sets and methodology parameters (FIG. 5A-5B). The reporting transformation module generates regulatory reporting records under a committed reporting schema mapping, each accompanied by a hardware-attestation quote binding it to the compliance attestation record (FIG. 5C). A methodology disclosure record specifies the committed supervisory factor table, alpha multiplier, netting determination, and rule-set versions in force (FIG. 5D). A tamper-evident methodology ledger organized as a Merkle accumulator records compliance attestation records, its root periodically published to an external public commitment channel (FIG. 5E).

### ENABLEMENT EXAMPLES

### Example 1 (Single-Venue Intel SGX Wrapping with SA-CCR Capital)

Consider a wrapper instance executing within an Intel SGX enclave at a regulated venue. The enclave measures the compliance code base into a measurement register and obtains a root attestation quote via the Intel attestation service. The intake interface ingests a native binary event contract C-1, associated position records, and pseudonymized participant-identity records over channels terminating within the enclave. The screening module applies the committed KYC/AML/sanctions rule set, integrating the HATIS account-linkage fingerprints and the VPCS calibrated insider-risk indicator (received as attested input) into a composite risk score, and produces a clear disposition. The jurisdictional mapping module maps C-1, under the committed U.S. CEA rule set, to a wrapped derivative instrument definition with assigned notional of 1,000,000 units and committed settlement mechanics. The capital treatment mapping module computes replacement cost =max(0, market value 40,000−net collateral 25,000)=15,000; potential future exposure under SA-CCR=alpha (1.4)×supervisory add-on (derived from the committed factor table on adjusted notional)×over-collateralization multiplier; and exposure at default=1.4×(replacement cost+potential future exposure). The attestation module emits a compliance attestation record binding the wrapped definition, the capital attributes, and commitments over inputs and methodology. A G-SIB counterparty verifies the record against the Intel attestation service and integrates the capital attributes into its regulatory capital determination—without reliance on the exchange operator and without seeing per-participant plaintext.

Confidential-Computation Enforcement Embodiment. In a confidential-computation enforcement embodiment, the entire capital-treatment computation, including the replacement cost, the SA-CCR potential future exposure, and the exposure-at-default, is performed only after the participant-identity and position records are decrypted within the enclave, and no plaintext of those records is written to host memory, persistent storage, or any interface outside the hardware trusted execution environment at any point during the computation interval. The resulting capital treatment attributes are bound, through the compliance attestation record, both to the hardware measurement register and to a cryptographic commitment over the committed supervisory factor table and alpha multiplier in force. A consuming institution that later attempts to substitute a more favorable supervisory factor, or to alter an ingested position, produces a record whose recomputed commitment no longer matches the attested commitment, and verification against the hardware-vendor attestation service fails. A relying regulator may additionally recompute the capital attributes from the bound methodology disclosure record and compare them against the attested values, detecting any non-conforming capital determination. The technical effect is a counterparty-credit-exposure determination that is simultaneously computed on confidential data, verifiable without disclosure of that data, and tamper-evident against alteration by any party including the party that benefits from the determination—a result not achievable by a software-only capital engine, in which the computing party can alter inputs or methodology without detection.

### Example 2 (Multi-Framework Institutional Consumption on Confidential VM)

Consider two institutions consuming wrapped instruments derived from the same native contract: a first institution subject to a first prudential capital framework and a second institution subject to a second framework. The wrapper, executing within an AMD SEV-SNP confidential virtual machine, selects under the committed jurisdictional rule set the capital framework applicable to each institution and binds the selected framework identifier into each institution's compliance attestation record, such that each institution receives capital treatment attributes computed under the framework applicable to it from the same underlying contract. A prudential regulator, acting as relying party, verifies each compliance attestation record against the AMD attestation service and confirms—from the bound methodology disclosure record—which supervisory factor table, alpha multiplier, and rule-set versions produced each institution's capital attributes, without instantiating a trusted execution environment of its own and without reliance on the exchange operator.
VII. Alternative Embodiments. The system may be practiced on any computer hardware providing the trusted-execution-environment properties described herein, and supports additional and successor TEE implementations and multi-vendor attestation. The committed capital mapping methodology is configurable to a plurality of institution-specific capital frameworks, and the committed jurisdictional, screening, and reporting rule sets are illustrative and non-limiting. The disclosure herein supports, and the applicant reserves the right to pursue in one or more continuation or divisional applications, claims of broader or differing scope, including without limitation claims directed to hardware-attested capital-treatment mapping of regulated financial instruments generally and claims directed to the attested instrument-wrapping mechanism independent of the prediction-market context. The foregoing embodiments are illustrative and non-limiting.

What is claimed is:

1. A regulatory-compliant wrapper system for transforming native prediction market contracts into institutionally consumable wrapped derivative instruments, comprising: at least one compliance processing engine configured to execute within a hardware trusted execution environment having a hardware measurement register and a hardware-rooted attestation key provisioned by a hardware vendor, the hardware trusted execution environment configured to load a measured compliance code base such that the contents of the hardware measurement register cryptographically bind to the loaded code base upon instantiation; an intake interface configured to ingest into the hardware trusted execution environment, over encrypted channels terminating at endpoints within the hardware trusted execution environment, native prediction market contract specifications, associated position records, and participant-identity records, wherein participant-identity records comprise pseudonymized identifiers derived from cryptographic hashes of know-your-customer attestation data and plaintext of said records does not exist outside the hardware trusted execution environment during a computation interval, the compliance processing engine being configured to integrate, as received attested input, account-linkage fingerprints and raw trade-integrity signals generated by a companion hardware-attested trade integrity system and a calibrated insider-risk indicator computed by a companion verified prediction confidence scoring system, the compliance processing engine itself neither generating said raw trade-integrity signals nor computing said calibrated insider-risk indicator; a screening module executing within the hardware trusted execution environment and configured to apply know-your-customer, anti-money-laundering, sanctions, and eligibility screening against a committed rule set sealed to the hardware identity of the hardware trusted execution environment, producing a screened record with a composite risk score and a disposition indicator; a jurisdictional mapping module executing within the hardware trusted execution environment and configured to map the native prediction market contract to a wrapped instrument definition with institution-specific treatment attributes assigned under a committed jurisdictional rule set, the treatment attributes identifying the regulatory designation applicable to the contract under the Commodity Exchange Act, the Securities Exchange Act of 1934, or an equivalent foreign regulatory regime; a capital treatment mapping module executing within the hardware trusted execution environment and configured to assign institution-specific capital treatment attributes to the wrapped instrument definition under a committed capital mapping methodology comprising a replacement cost component, a potential future exposure component computed under the Standardized Approach for Counterparty Credit Risk (SA-CCR) using a committed supervisory factor table and a committed alpha multiplier, and an exposure-at-default value, with netting applied under a committed netting determination; and an attestation module configured to produce a compliance attestation record cryptographically signed by the hardware-rooted attestation key and binding the wrapped instrument definition attributes and the capital treatment attributes to the contents of the hardware measurement register, to a cryptographic commitment over the ingested records, and to a cryptographic commitment over the committed rule sets and methodology parameters, wherein the capital treatment attributes are computed over participant-identity and position data that does not exist in plaintext outside the hardware trusted execution environment during the computation and are cryptographically bound such that no party, including an institution consuming the wrapped instrument, can alter the committed capital mapping methodology or the ingested records without invalidating verification of the compliance attestation record, and wherein the compliance attestation record, the wrapped instrument definition, and the capital treatment attributes are independently verifiable by a regulator or institutional counterparty against a hardware-vendor attestation service without participation of, or reliance on representations by, an operator of the prediction market exchange.

2. A method of producing a regulatory-compliant wrapped prediction market instrument, the method comprising: loading a measured compliance code base into a hardware trusted execution environment having a hardware measurement register and a hardware-rooted attestation key, such that the contents of the hardware measurement register cryptographically bind to the loaded code base upon instantiation; ingesting, into the hardware trusted execution environment over encrypted channels terminating at endpoints within the hardware trusted execution environment, native prediction market contract specifications, associated position records, and participant-identity records, wherein participant-identity records comprise pseudonymized identifiers derived from cryptographic hashes of know-your-customer attestation data and plaintext of said records does not exist outside the hardware trusted execution environment during a computation interval; applying, within the hardware trusted execution environment, know-your-customer, anti-money-laundering, sanctions, and eligibility screening against a committed rule set sealed to the hardware identity of the hardware trusted execution environment, producing a screened record with a composite risk score and a disposition indicator; mapping, within the hardware trusted execution environment, the native prediction market contract to a wrapped instrument definition with institution-specific treatment attributes assigned under a committed jurisdictional rule set, wherein the treatment attributes identify the regulatory designation applicable to the contract under the Commodity Exchange Act, the Securities Exchange Act of 1934, or an equivalent foreign regulatory regime as determined by the committed jurisdictional rule set in force during the computation; assigning, within the hardware trusted execution environment, institution-specific capital treatment attributes to the wrapped instrument definition under a committed capital mapping methodology comprising a replacement cost component, a potential future exposure component computed under the Standardized Approach for Counterparty Credit Risk using a committed supervisory factor table and a committed alpha multiplier, and an exposure at default value, with netting applied under a committed netting determination; generating, within the hardware trusted execution environment, regulatory reporting records from the wrapped instrument definition under a committed reporting schema mapping according to the treatment attributes assigned to the wrapped instrument; producing, within the hardware trusted execution environment, such that the capital treatment attributes are computed over participant and position data that does not exist in plaintext outside the hardware trusted execution environment and cannot be altered by any party without invalidating verification, a compliance attestation record cryptographically signed by the hardware-rooted attestation key and binding the wrapped instrument definition attributes and capital treatment attributes to the contents of the hardware measurement register, to a cryptographic commitment over the ingested records, and to a cryptographic commitment over the committed rule sets and methodology parameters; and exporting the wrapped instrument definition, the capital treatment attributes, the regulatory reporting records, the compliance attestation record, and a methodology disclosure record in a form independently verifiable by a regulator or institutional counterparty against a hardware-vendor attestation service without participation of, or reliance on representations by, an operator of the prediction market exchange.

3. A non-transitory computer-readable medium storing program instructions that, when executed within a hardware trusted execution environment of a computer system having a hardware measurement register and a hardware-rooted attestation key, cause the hardware trusted execution environment to perform operations comprising: loading a measured compliance code base such that the contents of the hardware measurement register cryptographically bind to the loaded code base upon instantiation; ingesting native prediction market contract specifications, associated position records, and participant-identity records over encrypted channels terminating at endpoints within the hardware trusted execution environment; applying know-your-customer, anti-money-laundering, sanctions, and eligibility screening against a committed rule set sealed to the hardware identity of the hardware trusted execution environment; mapping the native prediction market contract to a wrapped instrument definition under a committed jurisdictional rule set; assigning capital treatment attributes to the wrapped instrument definition under a committed capital mapping methodology comprising a replacement cost component, a potential future exposure component computed under the Standardized Approach for Counterparty Credit Risk using a committed supervisory factor table and a committed alpha multiplier, and an exposure-at-default value with netting applied under a committed netting determination; and producing, such that the capital treatment attributes are computed over data that does not exist in plaintext outside the hardware trusted execution environment and are tamper-evidently bound against alteration by any party, a compliance attestation record cryptographically signed by the hardware-rooted attestation key and binding the wrapped instrument definition attributes and capital treatment attributes to the contents of the hardware measurement register, to a cryptographic commitment over the ingested records, and to a cryptographic commitment over the committed rule sets and methodology parameters, independently verifiable against a hardware-vendor attestation service without participation of, or reliance on representations by, an operator of the prediction market exchange, wherein any modification of the ingested records, the committed rule sets, the methodology parameters, the wrapped instrument definition, or the capital treatment attributes invalidates verification of the compliance attestation record.

4. The system of claim 1, wherein the hardware trusted execution environment comprises at least one of Intel Software Guard Extensions, Intel Trust Domain Extensions, AMD Secure Encrypted Virtualization with Secure Nested Paging, ARM Confidential Compute Architecture, IBM Secure Execution for Linux, or any equivalent or successor confidential computing architecture providing hardware-rooted measurement, isolation, and remote attestation.

5. The system of claim 1, wherein the capital treatment mapping module computes, for each wrapped instrument definition: the replacement cost as the greater of zero and a difference between current market value and net collateral; the potential future exposure as a product of the committed alpha multiplier, an aggregate add-on derived from the committed supervisory factor table applied to an adjusted notional of the wrapped instrument, and a multiplier reflecting over-collateralization and negative mark-to-market; and the exposure-at-default as the committed alpha multiplier times a sum of the replacement cost and the potential future exposure, such that the capital treatment attributes are computed deterministically within the hardware trusted execution environment and bound into the compliance attestation record.

6. The system of claim 1, wherein the compliance processing engine integrates, as received attested input, the account-linkage fingerprints and raw trade-integrity signals from the companion hardware-attested trade integrity system and the calibrated insider-risk indicator from the companion verified prediction confidence scoring system into the composite risk score and the disposition indicator, the compliance processing engine performing neither raw trade-integrity detection nor calibrated insider-risk scoring.

7. The system of claim 1, wherein the jurisdictional mapping module maintains a plurality of jurisdiction-specific rule sets for at least U.S. Commodity Exchange Act-designated contract markets, U.S. securities exchanges under the Securities Exchange Act of 1934, and equivalent foreign regulatory regimes, and selects the applicable rule set according to the regulatory designation of the native prediction market contract and the institution consuming the wrapped instrument.

8. The system of claim 1, further comprising a position-limit enforcement module executing within the hardware trusted execution environment and configured to apply automated hard blocks or soft flags to wrapped instrument positions exceeding committed aggregate position limits, the position-limit determinations being bound into the compliance attestation record.

9. The system of claim 1, further comprising a tamper-evident methodology ledger configured to receive, under control of the hardware trusted execution environment, append-only records comprising compliance attestation records and methodology disclosure records, organized as a Merkle accumulator whose root is periodically committed to an external public commitment channel comprising at least one of a public blockchain, a regulator-operated commitment endpoint, and a consortium-operated commitment channel.

10. The system of claim 1, wherein the attestation module is further configured to bind into the compliance attestation record a methodology disclosure record specifying the committed supervisory factor table, the committed alpha multiplier, the committed netting determination, and the committed jurisdictional and screening rule-set versions in force during the computation, such that a relying party verifies which capital methodology and rule-set versions produced the capital treatment attributes.

11. The method of claim 2, wherein the applying step further comprises integrating, as received attested input, account-linkage fingerprints and raw trade-integrity signals from a companion hardware-attested trade integrity system and a calibrated insider-risk indicator from a companion verified prediction confidence scoring system into the composite risk score, the method neither generating said raw trade-integrity signals nor computing said calibrated insider-risk indicator.

12. The method of claim 2, wherein the assigning step further comprises computing the potential future exposure component as a product of the committed alpha multiplier, an aggregate add-on derived from the committed supervisory factor table applied to an adjusted notional, and a multiplier reflecting over-collateralization, and computing the exposure-at-default as the committed alpha multiplier times a sum of the replacement cost component and the potential future exposure component.

13. The method of claim 2, further comprising generating and exporting, together with the compliance attestation record, a zero-knowledge proof attesting that the capital treatment attributes were computed by the committed compliance code base under the committed capital mapping methodology on the committed ingested records, without disclosing per-participant position data.

14. The non-transitory computer-readable medium of claim 3, wherein the operations further comprise integrating, as received attested input, account-linkage fingerprints from a companion hardware-attested trade integrity system and a calibrated insider-risk indicator from a companion verified prediction confidence scoring system into a composite risk score, the operations neither generating raw trade-integrity signals nor computing the calibrated insider-risk indicator.

15. The non-transitory computer-readable medium of claim 3, wherein the committed capital mapping methodology is executed entirely within the hardware trusted execution environment over participant-identity and position data that is decrypted only within the hardware trusted execution environment and never exists in plaintext at any infrastructure outside the hardware trusted execution environment, and wherein the resulting capital treatment attributes are cryptographically bound, by the compliance attestation record, to the contents of the hardware measurement register and to a commitment over the committed supervisory factor table and alpha multiplier, such that the Standardized Approach for Counterparty Credit Risk computation produces a tamper-evident counterparty credit exposure determination that is verifiable by a relying party without the relying party accessing the underlying confidential participant data and without a trusted intermediary, and that is invalidated by any alteration of the methodology parameters or the ingested data after computation.

16. The non-transitory computer-readable medium of claim 3, wherein the committed capital mapping methodology is configurable to a plurality of institution-specific capital frameworks, the operations selecting, under the committed jurisdictional rule set, a capital framework applicable to the institution consuming the wrapped instrument and binding the selected framework identifier into the compliance attestation record, such that a first institution subject to a first capital framework and a second institution subject to a second capital framework each receive capital treatment attributes computed under the framework applicable to that institution.

17. The non-transitory computer-readable medium of claim 3, wherein the compliance attestation record and the regulatory reporting records are each formatted such that a relying party comprising a prudential regulator or institutional counterparty verifies the compliance attestation record against a hardware-vendor attestation service and verifies the cryptographic commitments contained therein, thereby confirming that the wrapped instrument definition and capital treatment attributes were produced by the measured compliance code base under the committed methodology on the attested inputs, without participation of, or reliance on representations by, an operator of the prediction market exchange and without the relying party instantiating a hardware trusted execution environment at infrastructure of the relying party.

18. The non-transitory computer-readable medium of claim 17, wherein the compliance attestation record comprises: (a) the contents of the hardware measurement register; (b) a hardware-vendor-signed chain-of-trust certificate; (c) a cryptographic commitment over the ingested native contract specifications, position records, and participant-identity records; (d) the wrapped instrument definition attributes; (e) the capital treatment attributes including replacement cost, potential future exposure, and exposure at default; (f) a cryptographic commitment over the committed supervisory factor table, alpha multiplier, netting determination, and jurisdictional and screening rule-set versions; and (g) a signature produced using the hardware-rooted attestation key.

19. The non-transitory computer-readable medium of claim 3, wherein the operations further comprise providing the wrapped instrument definition, the capital treatment attributes, and the compliance attestation record to an institutional counterparty that integrates the capital treatment attributes into a regulatory capital determination or prudential reporting workflow, the institutional counterparty relying upon the independently verifiable compliance attestation record to evidence the integrity of the capital treatment without reliance on representations of the prediction market exchange operator.

20. The non-transitory computer-readable medium of claim 3, wherein the operations further comprise binding into the compliance attestation record a methodology disclosure record sufficient for a relying party to independently recompute the capital treatment attributes from the wrapped instrument definition and the disclosed committed supervisory factor table, alpha multiplier, and netting determination, and to compare the recomputed attributes against the attested capital treatment attributes, such that a divergence between a relying party's recomputation and the attested capital treatment attributes is detectable by the relying party as evidence of a non-conforming capital determination.
